(19) United States
(12) Patent Application Publication
(10) Pub. No.: US 2026/0147538 A1
(43) Pub. Date: May 28, 2026

(54) ACCELERATOR OPTIMIZED USING ACTIVATION FUNCTION SPARSITY AND COMPUTATIONAL METHOD OF THE ACCELERATOR

(71) Applicant: KYUNGPOOK NATIONAL UNIVERSITY INDUSTRY-ACADEMIC COOPERATION FOUNDATION, Daegu (KR)

(72) Inventors: Daejin PARK, Daegu (KR); Seunghyun PARK, Daegu (KR)

(21) Appl. No.: 19/400,786

(22) Filed: Nov. 25, 2025

(30) Foreign Application Priority Data
Nov. 26, 2024 (KR) 10-2024-0171370

(51) Int. Cl. G06F 7/523; G06F 7/50

(52) U.S. Cl. CPC G06F 7/523; G06F 7/50

(57) ABSTRACT

An accelerator, which is optimized by using activation function sparsity, includes a memory and a processor, a Bit-Separable Multiplier (BSM) configured to divide a first data into upper bits and lower bits when first and second data are input, calculate a Partial Product (PP) value for the upper bits by multiplying the upper bits of the first data by the second data, and output a MAC value for the upper bits by performing a multiply-accumulate (MAC) operation, and a dynamic range decoder configured to predict an activation function output value based on the MAC value for the upper bits, and transmit a masking signal to the BSM for instructing to skip the multiplication operation of the lower bits of the first data and the second data when the activation function output value is 0, and set and output an output feature map value to 0.

### CROSS REFERENCE TO RELATED APPLICATIONS

This application claims priority to Korean Patent Application No. 10-2024-0171370, filed on Nov. 26, 2024, in the Korean Intellectual Property Office, which is incorporated by reference herein in its entirety.

### FIELD OF DISCLOSURE

The present disclosure relates to an accelerator optimized using sparsity of an activation function and a method of performing computation using the accelerator.

### BACKGROUND OF THE RELATED ART

The use of Artificial Intelligence (AI) is increasing for reasons such as convenience in daily life and improved productivity. Large language models based on Convolution Neural Network (CNN) and transformers may significantly enhance productivity in industries, such as design automation, as well as everyday life, such as in image searching and writing. Based on these advantages, various AI models have emerged, and extensive studies and research have been conducted to efficiently process computations.

The reason AI models can provide powerful functions is that they contain a large number of weights within the model, and the more weights there are, the better the model can learn the characteristics of a dataset. However, a side effect of having many weights is the increased computational load and memory burden. In particular, in convolutional layers, performance is limited by the amount of computation relative to the same data due to the reuse of data, while in the Fully Connected (FC) layers, performance is limited by memory bandwidth due to the characteristics of matrix-vector multiplication.

Therefore, various methods are being studied to reduce such computational load and memory burden, and among them, a method using sparsity is known to be the most effective. Sparsity refers to a characteristic that enables efficient resource utilization or computational optimization by having resources, data, or specific values exist or used only in some portion of the whole. In an actual operation, sparsity may be utilized for computation optimization through a method of reading such sparsity in a specific format and either turning off the computation device or skipping a computation related to sparse data.

Meanwhile, AI models are executed on a hardware accelerator that supports fast and efficient learning and inference, but the performance of the accelerator may be constrained by memory bandwidth and computational capability.

Therefore, there is a need for a technology that optimizes accelerator computations by applying activation function sparsity to the accelerator.

### SUMMARY OF THE INVENTION

The present disclosure has been devised to solve the above problems, and an object of the present disclosure is to provide an accelerator optimized using activation function sparsity and a method of performing computations using the accelerator.

According to an embodiment of the present disclosure, an accelerator, which is optimized using activation function sparsity, may include a memory and a processor, a bit separable multiplier (BSM) configured to divide a first data into upper bits and lower bits when the first data and a second data are input, calculate a partial product (PP) value for the upper bits by multiplying the upper bits of the first data by the second data, and output a MAC value for the upper bits by performing a multiply-accumulate (MAC) operation, and a dynamic range decoder configured to predict an activation function output value based on a MAC value for the upper bits, transmit a masking signal to the BSM instructing to skip a multiplication operation between the lower bits of the first data and the second data to the BSM when the activation function output value is 0, and set and output an output feature map value to 0.

According to another embodiment of the present disclosure, a method for performing computation using an accelerator optimized using activation function sparsity includes dividing, by a bit separable multiplier (BSM), a first data into upper bits and lower bits when the first data and a second data are input, calculating a partial product (PP) value for the upper bits by multiplying the upper bits of the first data by the second data, and outputting a MAC value for the upper bits by performing a multiply-accumulate (MAC) operation, and predicting, by a dynamic range decoder, the activation function output value based on the MAC value for the upper bits, transmitting a masking signal to the BSM indicating to skip the multiplication operation of the lower bits of the first data and the second data when the activation function output value is 0, and setting an output feature map value to 0 and outputting the output feature map value.

According to one aspect of the present disclosure described above, an accelerator optimized by using the sparsity of an activation function and a computation method using the accelerator solves the memory bandwidth bottleneck problem because only a portion of the operands need to be fetched from memory.

Furthermore, the processing speed is improved compared to a conventional multiplier, and when the same performance as the conventional multiplier is achieved, the area of the computation unit may be reduced, and power consumption may be greatly decreased.

### BRIEF DESCRIPTION OF THE DRAWINGS

FIG. 1 is a device diagram illustrating an internal block of an accelerator optimized using activation function sparsity according to an embodiment of the present disclosure.

FIG. 2 is a conceptual diagram illustrating an overall operation of the accelerator of FIG. 1.

FIG. 3 is a diagram illustrating an operation of a bit separable multiplier of FIG. 1.

FIG. 4 is a diagram illustrating an operation of a dynamic range decoder of FIG. 1.

FIG. 5 is a flowchart illustrating a computation process using an accelerator optimized using activation function sparsity according to an embodiment of the present disclosure.

### DETAILED DESCRIPTION OF THE PREFERRED EMBODIMENT

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure in connection with one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

Hereinafter, exemplary embodiments of the present disclosure will be described in more detail with reference to the drawings.

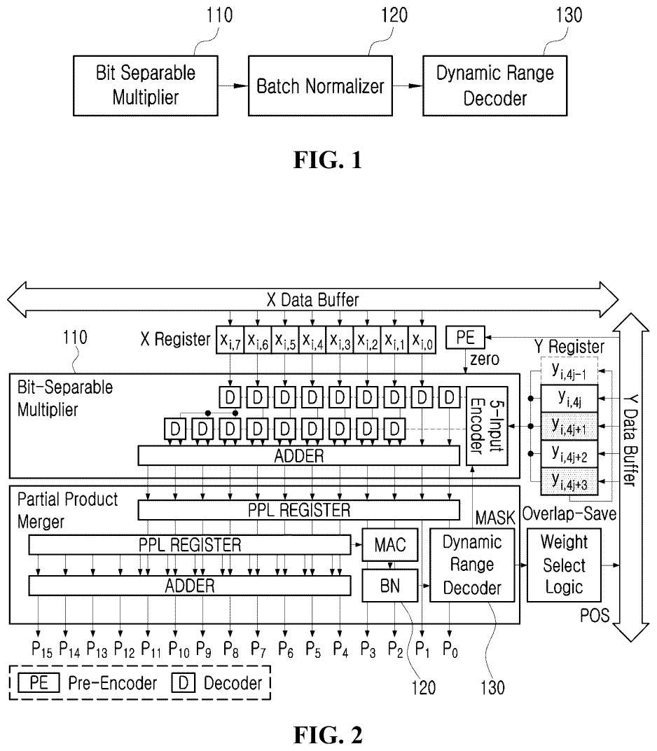

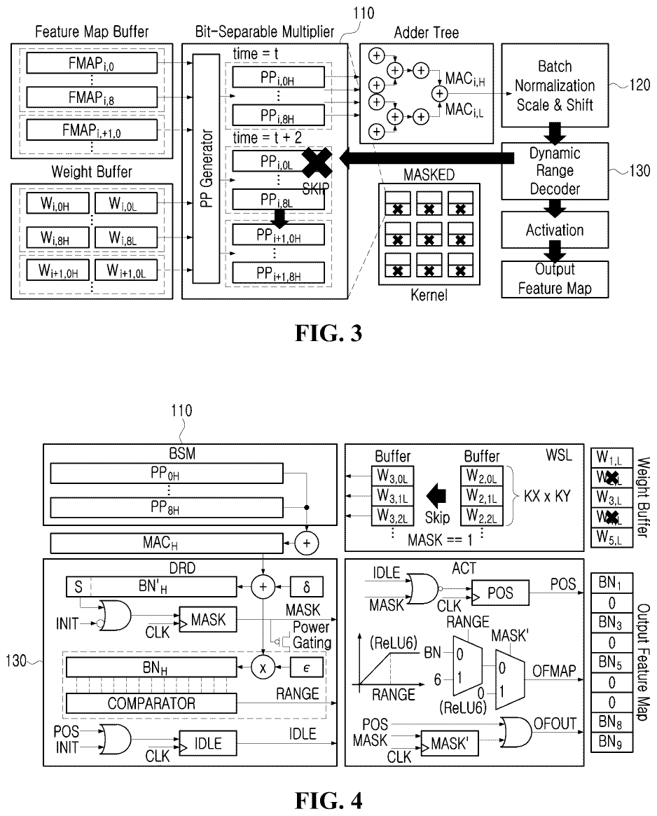

FIG. 1 is a device diagram illustrating an internal block of an accelerator optimized using activation function sparsity according to an embodiment of the present disclosure, FIG. 2 is a conceptual diagram illustrating an overall operation of the accelerator of FIG. 1, FIG. 3 is a diagram illustrating an operation of a bit-separable multiplier of FIG. 1, and FIG. 4 is a diagram illustrating an operation of a dynamic range decoder of FIG. 1.

The illustrated accelerator includes a Bit-Separable Multiplier (BSM) 110, a Batch Normalizer 120, and a Dynamic Range Decoder (DRD) 130.

When the first and second data are input, the BSM 110 may divide the first data into upper bits and lower bits, calculate a Partial Product (PP) value for the upper bits by multiplying the upper bits of the first data by the second data, and output a MAC value for the upper bits by performing a multiply-accumulate (MAC) operation.

More specifically, when the first and second data, for example, the Y data and the X data are input as shown in FIG. 2, the BSM 110 divides the Y data into the upper bits Y_{H} and the lower bit Y_{L}, and calculates the PP value for the upper bits PP_{H} by performing a multiplication operation on the Y_{H} and the X data as shown in Equation 1 below. In an embodiment of the present disclosure, as shown in FIG. 3, it is assumed that the Y data represents weight data and the X data is feature map data.

$$\begin{matrix}X \times {Y}_{H} = {\sum }_{i = 0}^{\frac{n}{4} - 1} {M}_{H , i} {2}^{2 i} X = P {P}_{H} \\ X \times {Y}_{L} = {\sum }_{i = 0}^{\frac{n}{4} - 1} {M}_{L , i} {2}^{2 i} X = P {P}_{L} \\ where , {M}_{i} = - 2 {y}_{i + 1} + {y}_{i} + {y}_{i - 1}\end{matrix} \qquad [ Equation 1 ]$$

Here, i denotes the bit index of the data, n denotes the bit width of data, y denotes each bit of Y data, and M denotes a modified booth coefficient according to the y value as shown in Table 1 below.

TABLE 1

| y₂ᵢ₊₁ | y₂ᵢ | y₂ᵢ₋₁ | Mᵢ | zeroᵢ | negᵢ | otᵢ | corᵢ |
|---|---|---|---|---|---|---|---|
| 0 | 0 | 0 | 0 | 1 | 0 | d | 0 |
| 0 | 0 | 1 | +1 | 0 | 0 | 1 | 0 |
| 0 | 1 | 0 | +1 | 0 | 0 | 1 | 0 |
| 0 | 1 | 1 | +2 | 0 | 0 | 0 | 0 |
| 1 | 0 | 0 | −2 | 0 | 1 | 0 | 1 |
| 1 | 0 | 1 | −1 | 0 | 1 | 1 | 1 |
| 1 | 1 | 0 | −1 | 0 | 1 | 1 | 1 |
| 1 | 1 | 1 | 0 | 1 | 1 | d | 0 |

As shown in Equation 1, the BSM 110 divides the bits of the Y data into two parts to calculate the PP value. Here, since both PP_{H} and PP_{L} are calculated in the same manner, the BSM 110 may share the same hardware resources and sequentially perform computation.

As shown in FIG. 2, the simplified adder structure may reduce hardware resources of the BSM 110 and the wiring compared to the conventional multiplier by excluding the DRD 130 and the partial product merger that merges the PP_{H} and PP_{L}. However, an increase in the addition operation steps of the multiplier reduces clock slack and increases the area of the multiplier. Thus, the simplified data path of the BSM 110 allows operation at higher clock frequencies, thereby achieving better performance by placing two BSM 110 units in the same area as the conventional multiplier.

The final multiplication result of the BSM 110 is calculated by summing PP_{H} and PP_{L}, each bit-shifted by half of the input bit length as shown in Equation 2 below.

$$\begin{matrix}X \times Y = {2}^{\frac{n}{2}} \times {\sum }_{i = 0}^{\frac{n}{4} - 1} {M}_{H , i} {2}^{2 i} X + {\sum }_{i = 0}^{\frac{n}{4} - 1} {M}_{L , i} {2}^{2 i} X \\ = {2}^{\frac{n}{2}} \times ( X \times {Y}_{H} ) + ( X \times {Y}_{L} ) \\ = {2}^{\frac{n}{2}} \times P {P}_{H} + P {P}_{L} \\ = ( P {P}_{H} << \frac{n}{2} ) + P {P}_{L}\end{matrix} \qquad [ Equation 2 ]$$

The following Equation 3 shows that the MAC operation of summing the multiplication products of all X data and Y data using an Adder Tree as shown in FIG. 3 may be divided into a sum, MAC_{H}, of all PP_{H}S, and a sum, MAC_{L}, of all PP_{L}s, each being bit-shifted by half of the input bit length. Here, since the MAC operation is a linear function, it may be calculated independently for the upper bits and the lower bits, respectively, similar to calculating the PP value.

$$\begin{matrix}MAC = {\sum }_{i = 0}^{K X \times K Y} {( X \times Y )}_{i} \\ = {\sum }_{i = 0}^{K X \times K Y} {( {2}^{\frac{n}{2}} \times P {P}_{H} \times P {P}_{L} )}_{i} \\ = {2}^{\frac{n}{2}} \times {\sum }_{i = 0}^{K X \times K Y} P {P}_{i , H} + {\sum }_{i = 0}^{K X \times K Y} P {P}_{i , L} \\ = {2}^{\frac{n}{2}} \times M A {C}_{H} + M A {C}_{L} \\ = ( MA {C}_{H} << \frac{n}{2} ) + M A {C}_{L}\end{matrix} \qquad [ Equation 3 ]$$

Here, KX represents the horizontal size of the convolutional kernel, and KY represents the vertical size of the convolutional kernel. For example, if a 3×5 matrix is used as a convolution kernel, then KX=3 and KY=5.

The DRD 130 predicts an activation function output value based on the MAC value for the upper bits (MAC_{H}) output from the BSM 110.

When the predicted activation function output value is 0, the DRD 130 transmits a masking signal to the BSM 110 instructing to skip the multiplication between the lower bits of the first data Y_{L} and the second data X. Then, the DRD 130 sets the output feature map value to 0 and outputs it.

When the predicted activation function output value is not 0, the BSM 110 multiplies the lower bits of the first data Y_{L} by the second data X as shown in Equation 1 described above to calculate the PP value for the lower bits PP_{L}, performs the MAC operation to derive the MAC value for the lower bits MAC_{L}, and outputs the multiplication result for all bits of the first data and the second data based on MAC_{H} and MAC_{L}. Then, the DRD 130 sets the output feature map value as a multiplication result for all bits of the first data and the second data and outputs the multiplication result.

Meanwhile, the batch normalizer 120 may calculate and normalize the mean and standard deviation of the MAC value for the upper bits output from the BSM 110, and then apply a predetermined scaling parameter and a shift parameter to output a batch normalization result value.

In more detail, the batch normalizer 120 first calculates and normalizes the mean u and the standard deviation σ of the MAC values as shown in Equation 4 below, and then adjusts the normalized values using the scaling parameter γ and the shift parameter β obtained during training. The normalized MAC value, that is, the batch normalization result value, is expressed as BN as shown in Equation 4 below.

$$\begin{matrix}MA {C}^{′} = \frac{M A C - μ}{σ} ( Normalize ) \\ BN = γ \times M A {C}^{′} + β ( Scale and Shift ) \\ ∴ BN = γ \times \frac{M A C - μ}{σ} + β\end{matrix} \qquad [ Equation 4 ]$$

The normalization method may vary depending on the training and inference process. The parameters μ, σ, γ, and β are calculated for each batch during training, whereas the moving averages as well as the stored γ and β values are used during inference. However, the operations for normalization, scaling, and shifting are fundamentally the same in both the training and inference processes, and since BN is composed entirely of linear functions, it can be calculated independently in the same way as the MAC operation.

The DRD 130 predicts the activation function output value based on the batch normalization result value output from the batch normalizer 120. That is, the DRD 130 predicts the activation function output value as 0 when the batch normalization result value is less than or equal to 0, or when the sign bit of the batch normalization result value is 1.

In this case, the DRD 130 predicts the activation function output value by using a ReLU (Rectified Linear Unit) activation function, and in particular, predicts the activation function output value by using the property of the ReLU function of outputting 0 for an input value less than 0, and outputting the input value as it is for an input value greater than or equal to 0.

In other words, when the BN value calculated through Equation 4 is less than or equal to 0, the DRD 130 predicts the activation function output value as 0, sets the output feature map value to 0, and outputs the set output feature map value. As such, since the DRD 130 decodes only the upper bits to identify cases where the activation function output value is 0, the BSM 110 may skip the multiplication operation on the lower bits. This reduces the total operation time, thereby reducing the time and energy required per training or inference cycle.

In order to determine whether the BN value is less than or equal to 0, the present disclosure transforms Equation 4 into Equation 5 as shown below, introducing new variables δ and ε. Specifically, BN′ is obtained by multiplying both sides of Equation 4 by

$$\frac{σ}{γ} ,$$

and if BN′ is less than or equal to 0, the activation function output value is predicted as 0.

$$\begin{matrix}\begin{matrix}BN = γ \times \frac{M A C - μ}{σ} + β & < 0 ?\end{matrix} \\ = \frac{γ}{σ} \times \{ M A C - μ + \frac{σ}{γ} β \} = ϵ \times {BN}^{′} \\ \begin{matrix}{BN}^{′} = M A C + ( - μ + \frac{σ}{γ} β ) = M A C + δ & < 0 ?\end{matrix} \\ \begin{matrix}where , & δ = - μ + \frac{σ}{γ} β , & ϵ = \frac{γ}{σ}\end{matrix}\end{matrix} \qquad [ Equation 5 ]$$

The most effective way to determine whether BN′ is less than or equal to 0 is to check whether a sign bit of BN′ is 1, as shown in FIG. 4. That is, when the most significant bit (MSB) of BN′ is 1, it represents negative values, and thus the multiplication operation on the lower bits may be skipped and the output feature map value may be set to 0. In this case, power is cut off by the masking signal for each kernel to prevent unnecessary computation, thereby enabling low-power operation.

Also, the DRD 130 may include an idle signal indicating a state of the DRD. Since the initial state and the state during BN_{L} calculation do not require the upper bits decoding, the state of the DRD is set to IDLE. In FIG. 4, the POS signal informs the weight selection logic whether a bit to be currently calculated is an upper bit or a lower bit. When calculating BN_{H}, the POS signal is set to LOW, and when calculating BN_{L}, the POS signal is set to HIGH. Therefore, when the POS signal is HIGH, the DRD state is set to IDLE in the next clock cycle.

In addition, in FIG. 4, the OFOUT signal represents the output timing of the output feature map, and the MASK signal is used to match the output timing of the OFPUT signal by outputting the MASK signal at the next clock cycle. Therefore, when BN_{L} is calculated (POS==1) or when MASK′ signal is 1, the output feature map is output. That is, when the signal MASK′ is 1, the output feature map value is output as 0, and when the signal MASK′ is 0, the output feature map value is output as the BN value by using the Multiplexer (MUX).

Table 2 below compares the timing and signals of the conventional multiplier with those of the BSM 110 of the present disclosure. According to Table 2, when the DRD 130 is in the RUN state and the masking signal is 0, the POS signal becomes 1 in the next clock cycle, which may be implemented as −(IDLE|MASK)(NOR).

TABLE 2

| | | | | | | | | |
|---|---|---|---|---|---|---|---|---|
| CLOCK | 1 | 2 | 3 | 4 | 5 | 6 | 7 | 8 |

Traditional Multiplier

| | | | | | | | | |
|---|---|---|---|---|---|---|---|---|
| BN | BN₁ | BN₂ | BN₃ | BN₄ | BN₅ | BN₆ | BN₇ | BN₈ |

Bit-Separable Multipler

| | | | | | | | | |
|---|---|---|---|---|---|---|---|---|
| DRD | IDLE | RUN | RUN | IDLE | IDLE | RUN | RUN | RUN |
| | IDLE | RUN | RUN | RUN | RUN | IDLE | RUN | RUN |
| MASK | 0 | 0 | 0 | 0 | 0 | 1 | 0 | 0 |
| | 0 | 1 | 1 | 0 | 1 | 0 | 0 | 1 |
| POS | 0 | 0 | 1 | 1 | 0 | 0 | 0 | 1 |
| | 0 | 0 | 0 | 0 | 1 | 0 | 0 | 1 |
| BN | BN_{1H} | BN_{3H} | BN_{1L} | BN_{3L} | BN_{7H} | BN_{8H} | BN_{10H} | BN_{8L} |
| | BN_{2H} | BN_{4H} | BN_{5H} | BN_{6H} | BN_{5L} | BN_{9H} | BN_{11H} | BN_{9L} |
| OFMAP | — | — | OF₁ | OF₃ | — | — | OF₇(0) | OF₈ |
| | — | — | OF₂(0) | OF₄(0) | OF₅ | OF₆(0) | — | OF₉ |

In the embodiment of the present disclosure, the configuration in which the DRD 130 predicts the activation function output value using the ReLU function has been described as an example, but the DRD 130 may also predict the activation function output value using the ReLU6 function, as shown in FIG. 4. The ReLU6 function is an activation function that is similar to the ReLU function but has an attribute of outputting 6 for an input value greater than or equal to 6. Therefore, if the BN_{H} value is decoded and MUX is used, the lower bit operation may be skipped by setting the output feature map value to 6 for a value greater than or equal to 6.

Fixed-point arithmetic divides numbers into integer and fractional parts based on a fixed decimal point, so upper bits decoding efficiently identifies cases greater than or equal to 6. Therefore, the ReLU6 may skip more lower-bit operations compared to the ReLU when using the same data.

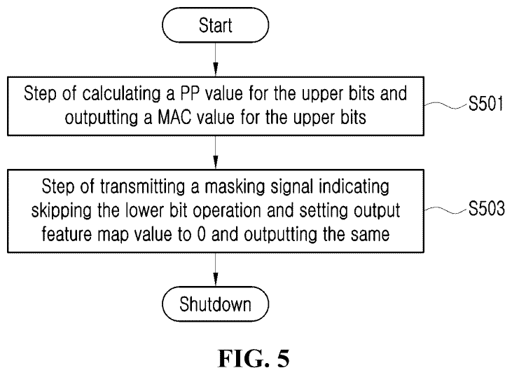

FIG. 5 is a flowchart illustrating the computation process of the accelerator optimized using activation function sparsity according to another embodiment of the present disclosure.

When the first and second data are input, the BSM 110 may divide the first data into an upper bit and a lower bit, calculate a PP value for the upper bit by multiplying the upper bit of the first data by the second data, and output a MAC value for the upper bit by performing a multiply-accumulate (MAC) operation. (S501)

Then, the dynamic range decoder (DRD) 130 may predict the activation function output value based on the MAC value for the upper bit. When the activation function output value is 0, a masking signal instructing to skip the lower bit operation, that is, the multiplication operation of the lower bits of the first data and the second data, is transmitted to the BSM 110, and an output feature map value is set and output to 0. (S503)

The operation method of the accelerator optimized using the activation function sparsity of the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

### DESCRIPTION OF SYMBOLS

110: Bit Separable Multiplier
120: Batch Normalizer
130: Dynamic Range Decoder

What is claimed is:

1. An accelerator optimized using activation function sparsity, the accelerator comprising:
a memory and a processor;
a BSM (Bit-Separable Multiplier) configured to divide a first data into upper bits and lower bits when the first data and a second data are input, calculate a Partial Product (PP) value for the upper bits by multiplying the upper bits of the first data by the second data, and output a MAC value for the upper bits by performing a multiply-accumulate (MAC) operation; and
a dynamic range decoder configured to predict an activation function output value based on the MAC value for the upper bits, and transmit a masking signal to the BSM instructing to skip a multiplication operation between the lower bits of the first data and the second data when the activation function output value is 0, and set and output an output feature map value to 0.

2. The accelerator of claim 1, further comprising a batch normalizer, configured to calculate and normalize a mean and a standard deviation of the MAC value for the upper bits, and output a batch normalization result value by applying a predetermined scaling parameter and a shift parameter, and
wherein the dynamic range decoder predicts the activation function output value based on the batch normalization result value.

3. The accelerator of claim 2, wherein the dynamic range decoder predicts the activation function output value as 0 when the batch normalization result value is less than or equal to 0, or when a sign bit of the batch normalization result value is 1.

4. The accelerator of claim 1, wherein, when the activation function output value is not 0:
the BSM calculates a PP value for the lower bits by multiplying the lower bits of the first data by the second data, derives a MAC value for the lower bits by performing the MAC operation, outputs a multiplication result for all bits of the first data and the second data based on the MAC value for the upper bits and the MAC value for the lower bits, and
the dynamic range decoder sets and outputs the output feature map value as the multiplication result for all bits of the first data and the second data.

5. A method of performing computation using an accelerator optimized using activation function sparsity, the method comprising:
dividing, by a Bit-Separable Multiplier (BSM), a first data into upper bits and lower bits when the first data and a second data are input;
calculating, by the BSM, a Partial Product (PP) value for the upper bits by multiplying the upper bits of the first data by the second data;
outputting, by the BSM, a MAC value for the upper bits by performing a multiply-accumulate (MAC) operation;
predicting, by a dynamic range decoder, an activation function output value based on the MAC value for the upper bits;
transmitting, by the dynamic range decoder, a masking signal to the BSM instructing to skip a multiplication operation of the lower bits of the first data and the second data when the activation function output value is 0; and
setting and outputting, by the dynamic range decoder, an output feature map value to 0.

6. The method of claim 5, further comprising:
calculating, by a batch normalizer, a mean and a standard deviation of the MAC value for the upper bits;
normalizing, by the batch normalizer, the calculated mean and standard deviation; and
outputting, by the batch normalizer, a batch normalization result value by applying a predetermined scaling parameter and a shift parameter,
wherein the dynamic range decoder predicts the activation function output value based on the batch normalization result value.

7. The method of claim 6, wherein the dynamic range decoder predicts the activation function output value as 0 when the batch normalization result value is less than or equal to 0, or when a sign bit of the batch normalization result value is 1.

8. The method of claim 5, further comprising, when the activation function output value is not 0:
calculating, by the BSM, a PP value for the lower bits by multiplying the lower bits of the first data by the second data;
deriving, by the BSM, a MAC value for the lower bits by performing the MAC operation;
outputting, by the BSM, a multiplication result for all bits of the first data and the second data based on the MAC value for the upper bits and the MAC value for the lower bits; and
setting and outputting, by the dynamic range decoder, the output feature map value as the multiplication result for all bits of the first data and the second data.
